(19) United States
(12) Patent Application Publication
(10) Pub. No.: US 2024/0076535 A1
(43) Pub. Date: Mar. 7, 2024

(54) ENVIRONMENT-FRIENDLY FRICTION MATERIAL COMPOSITION

(71) Applicant: Robert Bosch GmbH, Stuttgart (DE)

(72) Inventors: Zhigang Wang, Willowbrook, IL (US); Mark Phipps, Wayne, IN (US)

(21) Appl. No.: 17/930,289

(22) Filed: Sep. 7, 2022

(51) Int. Cl. C09K 3/14

(52) U.S. Cl. CPC C09K 3/149

(57) ABSTRACT

Friction material that is substantially free of elemental metals, metal alloys, and antimony trisulfide, wherein the solid lubricant includes a metal sulfide. The disclosed compositions of the friction material are believed to be more environment-friendly than conventional compositions. However, the substantial elimination of elemental metals, metal alloys, and antimony trisulfide from the disclosed compositions is performed in a manner that does not appear to substantially impact the friction performance and noise behavior of the corresponding brake components. Moreover, it is believed that at least some of the disclosed compositions increase the useful lifespan of the brake components and reduce wear of the rotors. The longer brake-components lifespan and lower rotor wear provide additional benefits in terms of reducing non-exhaust-related vehicle emissions, which further alleviates the environmental impact of traffic emissions.

### BACKGROUND

Various examples relate to friction materials and, more specifically but not exclusively, to friction coatings for brake components (for example, brake pads and brake linings, and others) of a vehicle, such as an automobile.

### SUMMARY

A typical braking system (also referred to as a “brake system”) of a wheeled vehicle converts kinetic energy of the moving vehicle to thermal energy through friction. This conversion is used to slow down and/or stop the vehicle. Over time and as a result of repeated braking events, components of the brake system may wear. For example, brake rotors or drums and brake pads wear as a result of use. It is known that these components must be replaced when the wear reaches a certain level. Brake pads typically wear out faster, usually requiring two or three replacements for every rotor/drum replacement. The main parts of a brake pad are the structural backing plate and the friction material that contacts the rotors.

Brake-pad wear can release friction material into the environment and can contribute to non-engine-exhaust, traffic-related emissions, particularly within areas with high traffic density and braking frequency. As a consequence, some governments and regulatory bodies have introduced regulations related to brake-pad compositions. For example, state-level legislation in the United States, such as Washington State SB 6557 or California State SB 346, substantially bans the use of certain chemicals in brake system components.

Disclosed herein are, among other things, various aspects, features, and embodiments of a friction material that is substantially free of elemental metals, metal alloys, and antimony trisulfide, wherein the solid lubricant includes a metal sulfide. Antimony trisulfide is a type of metalloid sulfide often used as a solid lubricant in conventional compositions. The disclosed compositions of the friction material are believed to be more environment-friendly than conventional compositions. However, the substantial elimination of elemental metals, metal alloys, and antimony trisulfide from the disclosed compositions is performed in a manner that does not appear to substantially impact the friction performance and noise behavior of the corresponding brake components. Moreover, it is believed that at least some of the disclosed compositions increase the useful lifespan of the brake components and reduce wear of the rotors. The longer brake-components lifespan and lower rotor wear provide additional benefits in terms of reducing non-exhaust-related vehicle emissions, which further alleviates the environmental impact of traffic emissions.

One example provides a friction material comprising: about 1.0% to about 10.0% by weight of a solid lubricant including a metal sulfide; about 6.0% to 15.0% by weight of a binder; about 2.0% to 15.0% by weight of an abrasive; and one or more fillers. The friction material is substantially free of elemental metal and metal alloy.

In some instances of the above friction material, the friction material is substantially free of elemental metal and metal alloy selected from the group consisting of elemental iron, steel, elemental tin, elemental zinc, elemental copper, elemental aluminum, elemental lead, elemental titanium, tin alloy, zinc alloy, copper alloy, aluminum alloy, and magnesium alloy.

Another example provides a friction material comprising: about 1.0% to about 10.0% by weight of a solid lubricant including a metal sulfide; about 6.0% to 15.0% by weight of a binder; about 2.0% to 15.0% by weight of an abrasive; and one or more fillers. The friction material is substantially free of metal and metal alloy in one or more forms selected from the group consisting of a fiber form, a chip form, and a powder form.

Yet another example provides a brake member for an automotive vehicle, the brake member comprising a friction material that includes: about 1.0% to about 10.0% by weight of a solid lubricant including a metal sulfide; about 6.0% to 15.0% by weight of a binder; about 2.0% to 15.0% by weight of an abrasive; and one or more fillers. The friction material is substantially free of elemental metal and metal alloy. Alternatively or in addition, the friction material is substantially free of metal and metal alloy in one or more forms selected from the group consisting of a fiber form, a chip form, and a powder form.

Yet another example provides a brake system for an automotive vehicle. The brake system comprises a rotor disk and a brake member. The brake member comprises a friction material that includes: about 1.0% to about 10.0% by weight of a solid lubricant including a metal sulfide; about 6.0% to 15.0% by weight of a binder; about 2.0% to 15.0% by weight of an abrasive; and one or more fillers. The friction material is substantially free of elemental metal and metal alloy. Alternatively or in addition, the friction material is substantially free of metal and metal alloy in one or more forms selected from the group consisting of a fiber form, a chip form, and a powder form.

### BRIEF DESCRIPTION OF THE DRAWINGS

Other aspects, features, embodiments, and benefits will become more fully apparent, by way of example, from the following detailed description and the accompanying drawings, in which:

FIG. 1 is a schematic diagram illustrating a brake system in which some example embodiments may be practiced.

FIG. 2 is a table illustrating friction material compositions according to several non-limiting examples.

FIG. 3 graphically shows representative test results of burnished friction levels obtained in compliance with the SAE J2522 standard, Section 2.0, protocol according to some examples.

### DETAILED DESCRIPTION

In the following description, numerous details are set forth, such as example compositions of matter, example apparatus, example methods, and the like, in order to provide an understanding of one or more aspects of the present disclosure. It will be readily apparent to a person of ordinary skill in the pertinent art that these specific details are mere examples that are not intended to limit the scope of this application.

Any numerical range recited herein includes all values from the lower value to the upper value. For example, if a range is stated as 1% to 50%, it is intended that the narrower ranges thereof, such as 2% to 40%, 10% to 30%, 1% to 3%, etc., are expressly enumerated by said statement. These specific examples represent only a limited subset of what is intended to be covered, and all possible combinations of numerical values between and including the lowest value and the highest value of the enumerated range are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so that, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75th Ed., inside cover, and specific functional groups are generally defined as described therein. Additionally, the present disclosure relies on general principles of organic chemistry, inorganic chemistry, and material science, as accepted in the pertinent arts. For example, specific functional moieties and reactivity in accordance with some of such principles are described in Organic Chemistry, Thomas Sorrell, University Science Books, Sausalito, 1999; Smith and March, March's Advanced Organic Chemistry, 5th Edition, John Wiley & Sons, Inc., New York, 2001; Larock, Comprehensive Organic Transformations, VCH Publishers, Inc., New York, 1989; Carruthers, Some Modern Methods of Organic Synthesis, 3rd Edition, Cambridge University Press, Cambridge, 1987, the entire contents of each of which are incorporated herein by reference.

Herein, the term “substantially free of” a component means that a referred-to composition contains the component in an amount of less than 0.5% by weight of the composition. This includes less than 0.4% by weight, less than 0.3% by weight, less than 0.2% by weight, less than 0.1% by weight, less than 0.05% by weight, and less than 0.01% by weight. Compositions “substantially free of” a component also include compositions that are completely free of that component. As a non-limiting example, a composition is understood to be “substantially free” or “free” of a substance, where that substance is not deliberately added in the process of manufacturing the composition, but may be inadvertently introduced in trace or undetectable amount via contamination or due to a corresponding impurity in one or more raw materials.

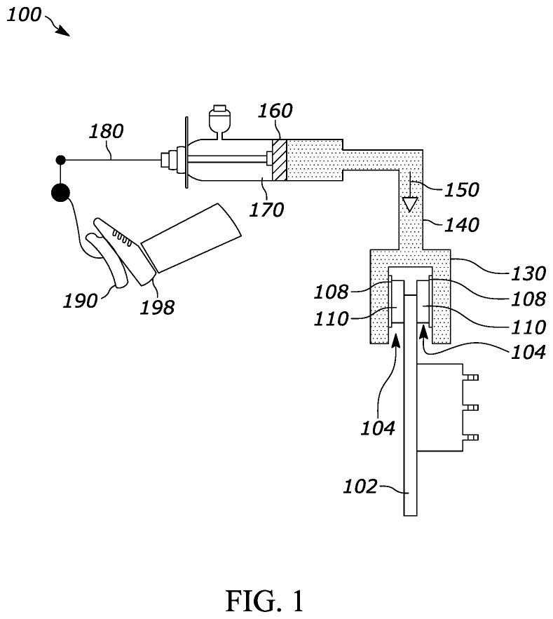

FIG. 1 is a schematic diagram illustrating a brake system 100 in which some example embodiments may be practiced. The brake system 100 comprises a rotor disk 102, a surface 104 of which is used as a frictional surface. In the shown example, the surface 104 has portions thereof on opposite sides of the rotor disk 102. Each of the surface portions is contacted by a respective one of brake pads 110 when brakes are applied. Each of the brake pads 110 is fixedly attached to a respective structural backing plate 108. The backing plate 108 may be a solid metal plate, and the friction material lining in the form of a brake pad 110 may be attached to the backing plate 108 via rivets or high-temperature adhesives. When the brake pads 110 contact the surface 104, the rotation of the rotor disk 102 slows down or stops, thereby causing the rotation of the vehicle's wheel (not explicitly shown in FIG. 1) fixedly attached to the rotor disk 102 to slow down or stop as well. The friction material is a portion of the brake member 108/110 that converts the vehicle's kinetic energy into heat. Advantageously, the friction material(s) disclosed herein can withstand relatively high temperatures without excessive wear.

In operation, when a driver's foot 198 steps on a brake pedal 190, a push rod 180 pushes on and applies pressure to a piston 160 of a master cylinder 170. This pressure causes a brake fluid 150 to move out of the master cylinder 170 into brake lines or tubes 140 connected to a brake caliper 130. The flow of the brake fluid 150 causes hydraulic pressure to be applied to pistons (not explicitly shown in FIG. 1) of the brake caliper 130. As the pistons move under the applied hydraulic pressure, the piston movement causes the structural backing plates 108 and the brake pads 110 to move as well and further causes the brake pads 110 to press against the surface 104 of the rotor disk 102. The force with which the brake pads 110 push on the surface 104 of the rotor disk 102 depends on the magnitude and duration of the force applied by the driver's foot 198 to the brake pedal 190. Releasing the brake pedal 190 allows a return mechanism for the involved parts to return those parts to the initial position, which causes the displaced brake fluid 150 to return to the master cylinder 170, thereby readying the brake system 100 for another braking action.

At least some embodiments disclosed herein provide a friction material for the brake pads 110. In some examples, the friction material is a non-asbestos organic (NAO) friction composite. The disclosed compositions of the friction material tend to be more environment-friendly than conventional compositions. For example, at least some of the disclosed compositions are free of elemental metals and of metal alloys, e.g., in the form of metal/alloy fibers, metal/alloy filaments, metal/alloy chops or chips, metal/alloy powders, or metal/alloy dust. At least some of the disclosed compositions are free of metallic copper, steel, aluminum, zinc, and/or tin. At least some of the disclosed compositions are free of antimony sulfide, e.g., antimony trisulfide, a known undesired chemical. The substantial elimination of various forms of elemental metals, metal alloys, and antimony trisulfide from the disclosed friction materials is performed in the context of environment-friendly compositions and in a manner that does not sacrifice the friction performance and noise behavior of the corresponding brake pads 110. Moreover, at least some of the disclosed compositions tend to increase the useful lifespan of the corresponding brake pads 110 and to reduce wear of the rotor disks 102. The longer brake-pad lifespan and lower rotor wear provide an additional benefit in terms of reducing non-exhaust-related vehicle emissions, which further alleviates the environmental impact of traffic-related emissions in general and braking-related emissions in particular.

A friction material disclosed herein can be formed into a brake pad (e.g., 110) or lining using known manufacturing processes. Such processes generally include mixing (such as dry blending), molding, and curing (stabilization) steps. A hot molding process at temperatures between 150° C. and 200° C. can be used, depending upon the reactivity of the binder (resin), the pad size, and other pertinent characteristics. The brake pad 110 prepared from the disclosed friction material can be applied to the backing plate 108 via, for example, an adhesive, rivets, or any other conventional application means. In some embodiments, the brake pad 110 is formed around a metal tang, and/or another element, such as a friction material wear indicator.

While the brake system 100 is described above in reference to a friction material being disposed or coated upon a backing plate of a brake pad, various embodiments are not so limited. More specifically, it should be understood that friction materials according to the present disclosure can similarly be applied to other surfaces. For example, the friction material can be disposed upon at least a region of a brake disk, brake drum, clutch plate, or other surface that may be subject to abrasion or wear during use. Additionally, while brake pads of an automotive vehicle have been described above, various uses of the friction material(s) disclosed herein are not limited to automotive vehicles, and can be applied to, for example, bicycles, motorcycles, airplanes, or vehicles having a brake assembly or otherwise abraded surfaces.

According to various examples, a friction material composition includes a binder, a solid lubricant, abrasive particles, at least one filler, and optional fiber. The filler may be an organic filler, an inorganic filler, or a suitable combination of organic and inorganic fillers. In some examples, the binder can be a phenolic and/or thermosetting binder. The ingredients of the composition are typically mixed together, e.g., in a conventional mixer. The mixture is pressed in a mold and baked to form a rigid, heat-resistant composite suitable for the brake pads 110.

The binder generally forms approximately 6% to 15% by weight of the final friction material composition. One example ingredient of the binder is a phenolic resin, which may be used by itself in some cases. Some binder formulations may be modified to include, in addition to a phenolic resin, one or more of silicone, acrylic, epoxy, and nitrite modifiers. In other examples, other suitable binder materials may also be used. In some examples, the binder system may comprise a mixture of two different types of binder systems, at least one of which is typically a phenolic-type resin. The binder typically provides a thermosetting matrix that holds all other ingredients together in the final friction material composition.

The fibers generally form approximately 0% to 20% by weight of the final friction material composition. That is, some examples of the friction material composition are fiber free. Example fibers that can be used in the friction material composition include one or more non-metal fibers, such as cellulose fiber, aramid fiber, polyacrylonitrile (PAN) fiber, acrylic fiber, cotton fiber, ceramic fiber, mineral fiber or mineral wool fiber, and various combinations thereof. In some examples, the fiber can be mixed into the mixture in the form of chips or powder. The used fibers are substantially free of elemental metals and metal alloys. The fibers are typically provide integrity and structural strength for the corresponding friction material. In some examples, various fibers and fiber lengths may be mixed to improve pertinent characteristics of the friction material. Some fiber formulations may be free of aramid for environmental reasons. Herein, a “metal” or a “metal alloy” is a solid material that is typically hard, shiny, malleable, fusible, and ductile, with good electrical and thermal conductivity (e.g., iron, tin, zinc, copper, and aluminum, and alloys such as brass and steel). Herein, graphite and various derivatives thereof are not considered to be a “metal” or a “metal alloy.”

The solid lubricant generally forms approximately 1% to 10% by weight of the final friction material composition. The solid lubricant is included in the friction material to reduce brake-pad and rotor-disk wear during service. In various examples, the used solid lubricant is antimony free. An example ingredient of the solid lubricant is a metal sulfide selected from: iron sulfide (e.g. FeS, Fe₂S₃, or Fe₃S₄), zinc sulfide (e.g., ZnS), bismuth sulfide (e.g., Bi₂S₃), manganese sulfide (e.g., MnS, MnS₂, or Mn₂S₃), and tin sulfide (e.g., SnS or SnS₂). The metal sulfides may be selected from transition metal sulfides and/or post-transition metal sulfides. Some of the selected metal sulfides may be semiconductors, e.g., wideband (>2 eV) semiconductors. Some formulations of the solid lubricant may include various combinations of two or more different non-antimony sulfides and include at least one metal sulfide.

The friction material may comprise at least 1.0%, at least 2.0%, at least 3.0%, at least 4.0%, at least 5.0%, at least 6.0%, at least 7.0%, at least 8.0%, or at least 9.0% by weight of non-antimony sulfide. The friction material may comprise 10.0% or less, 9.0% or less, 8.0% or less, 7.0% or less, 6.0% or less, 5.0% or less, 4.0% or less, 3.0% or less, 2.0% or less, or 1.0% or less by weight of non-antimony sulfide. The friction material may comprise about 1.0% to about 8.0%, about 1.0% to about 6.0%, about 1.0% to about 5.0%, about 1.0% to about 4.0%, or about 2.0% to about 4.0% by weight of non-antimony sulfide. In some examples, the friction material comprises from about 1.0% to about 6.0%, such as about 2.0% to about 4.0% by weight of non-antimony sulfide. In some examples, the friction material comprises about 3.0%, about 4.0%, or about 5.0% by weight of non-antimony sulfide.

The abrasive generally forms approximately 2% to 15% by weight of the final friction material composition. Example abrasives that can be used in the friction material composition include alumina, magnesium oxide, zirconium silicate (or zircon flour), silica, silicon dioxide, silicon carbide, mullite, iron chromite, complex mineral silicates such as calcium magnesium silicate, calcium magnesium zirconium silicate, calcium magnesium aluminum silicate, and magnesium aluminum silicate. Abrasives are typically classified by their Mohs hardness. Hard abrasives, i.e., the abrasives with higher values on the Mohs hardness scale, are typically used in relatively low concentrations, whereas mild abrasives, i.e., the abrasives with lower values on the Mohs hardness scale, are typically used in higher concentrations to achieve the same desired friction level.

The friction material may comprise at least 4.0%, at least 6.0%, at least 8.0%, at least 10.0%, at least 12.0%, or at least 14.0% by weight of an abrasive. The friction material may comprise 15.0% or less, 13.0% or less, 11.0% or less, 9.0% or less, 7.0% or less, or 5.0% or less by weight of an abrasive. The friction material may comprise about 4.0% to about 14.0%, about 5.0% to about 13.0%, or about 6.0% to about 12.0% by weight of an abrasive.

The fillers and other ingredients included in the friction material generally form the remainder, e.g., approximately 20% to 80%, of the final composition of the friction material. Organic fillers as disclosed herein may include, but are not limited to, melamine dust, polymerized cashew nut shell liquid (CNSL) dust, ground rubber particles, cellulose, and various combinations thereof. Inorganic fillers as disclosed herein may include, but are not limited to, barium sulfate, wollastonite, talc, titanate, calcium carbonate, calcium fluoride, lime, coal, graphite, coke, activated carbon, glass bubbles and/or glass beads (e.g., extendospheres), mica, vermiculite, and various combinations thereof. The other ingredients may be used as modifiers to create specific performance characteristics. For example, the other ingredients may be used to provide bulk to the formulation, reduce cost, provide noise reduction, and help with coating the rotor disk surface 104 with a relatively uniform friction transfer layer.

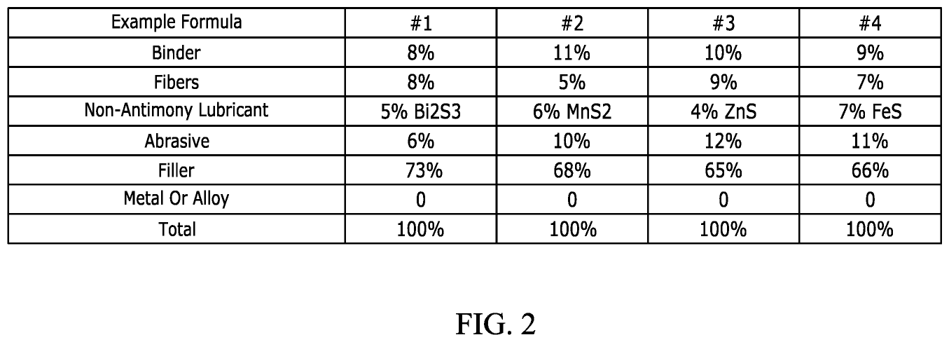

FIG. 2 is a table illustrating several non-limiting examples of friction material compositions according to some embodiments. In the shown examples, the binder portion is in the range between 8% and 11% by weight of the friction material composition. The fiber portion is in the range between 5% and 9% by weight of the friction material composition. The solid lubricant portion is in the range between 4% and 7% by weight of the friction material composition. The abrasive portion is in the range between 6% and 12% by weight of the friction material composition. The filler portion is in the range between 65% and 73% by weight of the friction material composition.

As shown in FIG. 2, the composition #1 comprises bismuth sulfide (Bi₂S₃), which is a post transition-metal sulfide. Each of the compositions ##2-4 comprises a respective transition metal sulfide. The shown examples illustrate that the metals in the metal sulfides can be divalent, trivalent, and tetravalent. As already indicated above, metal sulfides having a monovalent metal therein can also be used. All of the compositions ##1-4 are free of antimony and also free of elemental metals and metal alloys. For example, the compositions ##1-4 are free of elemental metals, such as elemental iron, tin, zinc, copper, lead, magnesium, and aluminum and are also free of metal alloys, such as various alloys of iron (e.g., steel, stainless steel, cast iron, tool steel, alloy steel) and various alloys of aluminum, copper, tin, zinc, and magnesium.

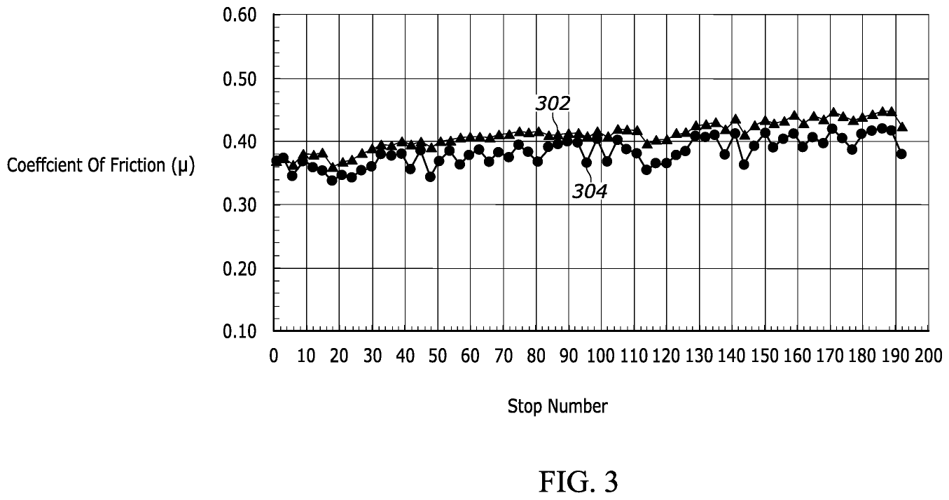

FIG. 3 graphically shows representative test results of burnished friction levels obtained in compliance with the SAE J2522 standard, Section 2.0, according to some examples. More specifically, a curve 302 shown in FIG. 3 plots the estimated coefficient of friction (II) for a representative friction material disclosed herein. A curve 304 also shown in FIG. 3 is a reference curve that plots the estimated coefficient μ for a copper-free NAO friction material containing antimony trisulfide (Sb₂S₃).

One method of mitigating the effects of initial fade is via scorching or burnishing. Burnishing is a method of pre-conditioning at least the top layers of the friction material by subjecting the friction material to bursts of mechanical force and/or heat prior to installation. Pre-conditioning can also be used to remove surface discontinuities in the surface of the friction material which can improve surface contact, e.g., between the friction material and the rotor disk (e.g., 102), and thus improve performance. As indicated in FIG. 3, the friction material disclosed herein achieves a steady-state μ value of about 0.40, which is higher than the steady-state μ value of the comparative copper-free NAO friction material with Sb₂S₃. The curve 302 also indicates a better performance consistency (e.g., smaller variations) than the curve 304.

Further tests directed at evaluating the noise behavior of the disclosed friction materials revealed that the generated noise levels are similar to those of the comparative copper-free NAO friction material with Sb₂S₃. Moreover, at least some of the disclosed compositions also tend to beneficially reduce weight loss of the brake pads, reduce wear of the rotors, and increase the useful lifespan of the brake members.

According to an example embodiment disclosed above, e.g., in the summary section and/or in reference to any one or any combination of some or all of FIGS. 1-3, provided is a friction material for a brake system (e.g., 100), the friction material comprising: about 1.0% to about 10.0% by weight of a solid lubricant including a metal sulfide; about 6.0% to 15.0% by weight of a binder; about 2.0% to 15.0% by weight of an abrasive; and one or more fillers; and wherein the friction material is substantially free of elemental metal and metal alloy.

In some embodiments of the above friction material, the friction material is substantially free of elemental metal and metal alloy selected from the group consisting of elemental iron, steel, elemental tin, elemental zinc, elemental copper, elemental aluminum, elemental lead, elemental titanium, tin alloy, zinc alloy, copper alloy, aluminum alloy, and magnesium alloy. Herein, brass is an example of “copper alloy” and is also an example of “zinc alloy.”

In some embodiments of any of the above friction materials, the friction material further comprises less than about 20.0% by weight of non-metal fiber.

According to another example embodiment disclosed above, e.g., in the summary section and/or in reference to any one or any combination of some or all of FIGS. 1-3, provided is a friction material for a brake system (e.g., 100), the friction material comprising: about 1.0% to about 10.0% by weight of a solid lubricant including a metal sulfide; about 6.0% to 15.0% by weight of a binder; about 2.0% to 15.0% by weight of an abrasive; and one or more fillers; and wherein the friction material is substantially free of metal and metal alloy in one or more forms including some or all of a fiber form, a filament form, a wool form, a chop form, a chip form, a wire form, and a powder form.

In some embodiments of the above friction material, the friction material further comprises about 0.1% to 20.0% by weight of non-metal fiber.

In some embodiments of any of the above friction materials, the friction material further comprises less than about 20.0% by weight of non-metal fiber.

In some embodiments of any of the above friction materials, the non-metal fiber is selected from the set consisting of cellulose fiber, aramid fiber, polyacrylonitrile fiber, acrylic fiber, cotton fiber, ceramic fiber, and mineral wool fiber.

In some embodiments of any of the above friction materials, the one or more fillers include one or both of an inorganic filler and an organic filler.

In some embodiments of any of the above friction materials, the inorganic filler is selected from the set consisting of barium sulfate, wollastonite, talc, titanate, calcium carbonate, calcium fluoride, lime, coal, graphite, coke, activated carbon, glass bubbles, glass beads, and vermiculite.

In some embodiments of any of the above friction materials, the organic filler is selected from the set consisting of melamine dust, polymerized cashew nut shell liquid dust, ground rubber particles, and cellulose.

In some embodiments of any of the above friction materials, the friction material is substantially free of one or both of the metal and the metal alloy in any form.

In some embodiments of any of the above friction materials, the friction material is substantially free of antimony.

In some embodiments of any of the above friction materials, the metal sulfide includes a transition metal sulfide or a post-transition metal sulfide.

In some embodiments of any of the above friction materials, the metal sulfide includes a sulfide of a monovalent metal, a sulfide of a divalent metal, a sulfide of a trivalent metal, or a sulfide of a tetravalent metal.

In some embodiments of any of the above friction materials, the metal sulfide is selected from the set consisting of an iron sulfide, a zinc sulfide, a bismuth sulfide, a manganese sulfide, and a tin sulfide.

In some embodiments of any of the above friction materials, the binder comprises phenol-formaldehyde resin.

In some embodiments of any of the above friction materials, the abrasive is selected from the set consisting of alumina, magnesium oxide, zirconia, zirconium silicate, silica, silicon dioxide, silicon carbide, mullite, mica, iron chromite, calcium magnesium silicate, calcium zirconium silicate, calcium magnesium aluminum silicate, and magnesium aluminum silicate.

In some embodiments of any of the above friction materials, the friction material consists of, in total of 100% by weight: about 4.0% to about 7.0% by weight of the solid lubricant; about 8.0% to 11.0% by weight of the binder; about 6.0% to 12.0% by weight of the abrasive; about 5.0% to 9.0% by weight of non-metal fiber; and about 65.0% to 73.0% by weight of the one or more fillers.

In some embodiments of any of the above friction materials, the binder provides a thermosetting matrix to hold together at least the solid lubricant, the abrasive, and the one or more fillers.

According to yet another example embodiment disclosed above, e.g., in the summary section and/or in reference to any one or any combination of some or all of FIGS. 1-3, provided is a brake member (e.g., 108/110) for an automotive vehicle, the brake member comprising a friction material that includes: about 1.0% to about 10.0% by weight of a solid lubricant including a metal sulfide; about 6.0% to 15.0% by weight of a binder; about 2.0% to 15.0% by weight of an abrasive; and one or more fillers; and wherein the friction material is substantially free of elemental metal and metal alloy in one or more forms including some or all of a fiber form, a filament form, a wool form, a chop form, a chip form, and a powder form.

According to yet another example embodiment disclosed above, e.g., in the summary section and/or in reference to any one or any combination of some or all of FIGS. 1-3, provided is a brake system (e.g., 100) for an automotive vehicle, the brake system comprising: a rotor disk (e.g., 102); and a brake member (e.g., 108/110) comprising a friction material that includes: about 1.0% to about 10.0% by weight of a solid lubricant including a metal sulfide; about 6.0% to 15.0% by weight of a binder; about 2.0% to 15.0% by weight of an abrasive; and one or more fillers; and wherein the friction material is substantially free of elemental metal and metal alloy in one or more forms including some or all of a fiber form, a filament form, a wool form, a chop form, a chip form, and a powder form.

It is to be understood that the above description is intended to be illustrative and not restrictive. Many implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed subject matter incorporate more features than are expressly recited in each claim. Rather, as the following claims reflect, inventive subject matter lies in fewer than all features of a single disclosed example. Thus, the following claims are hereby incorporated into the Detailed Description, with each claim standing on its own as a separately claimed subject matter.

While this disclosure includes references to illustrative examples, this specification is not intended to be construed in a limiting sense. Various modifications of the described aspects, features, and examples are possible.

Unless explicitly stated otherwise, each numerical value and range should be interpreted as being approximate as if the word “about” or “approximately” preceded the value or range.

What is claimed is:

1. A friction material for a brake system, the friction material comprising:
about 1.0% to about 10.0% by weight of a solid lubricant including a metal sulfide;
about 6.0% to 15.0% by weight of a binder;
about 2.0% to 15.0% by weight of an abrasive; and
one or more fillers; and
wherein the friction material is substantially free of metal and metal alloy in one or more forms selected from the group consisting of a fiber form, a chip form, and a powder form.

2. The friction material of claim 1, further comprising less than about 20.0% by weight of non-metal fiber.

3. The friction material of claim 2, wherein the non-metal fiber is selected from the group consisting of cellulose fiber, aramid fiber, polyacrylonitrile fiber, acrylic fiber, cotton fiber, ceramic fiber, and mineral wool fiber.

4. The friction material of claim 1, wherein the one or more fillers include one or both of an inorganic filler and an organic filler.

5. The friction material of claim 4, wherein the inorganic filler is selected from the group consisting of barium sulfate, wollastonite, talc, titanate, calcium carbonate, calcium fluoride, lime, coal, graphite, coke, activated carbon, glass bubbles, glass beads, and vermiculite.

6. The friction material of claim 4, wherein the organic filler is selected from the group consisting of melamine dust, polymerized cashew nut shell liquid dust, ground rubber particles, and cellulose.

7. The friction material of claim 1, wherein the friction material is substantially free of one or both of the metal and the metal alloy in any form.

8. The friction material of claim 1, wherein the friction material is substantially free of antimony.

9. The friction material of claim 1, wherein the metal sulfide includes a transition metal sulfide or a post-transition metal sulfide.

10. The friction material of claim 1, wherein the metal sulfide includes a sulfide of a monovalent metal, a sulfide of a divalent metal, a sulfide of a trivalent metal, or a sulfide of a tetravalent metal.

11. The friction material of claim 1, wherein the metal sulfide is selected from the group consisting of an iron sulfide, a zinc sulfide, a bismuth sulfide, a manganese sulfide, and a tin sulfide.

12. The friction material of claim 1, wherein the binder comprises phenol-formaldehyde resin.

13. The friction material of claim 1, wherein the abrasive is selected from the group consisting of alumina, magnesium oxide, zirconia, zirconium silicate, silica, silicon dioxide, silicon carbide, mullite, mica, iron chromite, calcium magnesium silicate, calcium zirconium silicate, calcium magnesium aluminum silicate, and magnesium aluminum silicate.

14. The friction material of claim 1, wherein the friction material consists of, in total of 100% by weight:
about 4.0% to about 7.0% by weight of the solid lubricant;
about 8.0% to 11.0% by weight of the binder;
about 6.0% to 12.0% by weight of the abrasive;
about 5.0% to 9.0% by weight of non-metal fiber; and
about 65.0% to 73.0% by weight of the one or more fillers.

15. The friction material of claim 1, wherein the binder provides a thermosetting matrix to hold together at least the solid lubricant, the abrasive, and the one or more fillers.

16. A brake member for an automotive vehicle, the brake member comprising the friction material of claim 1.

17. A brake system for an automotive vehicle, the brake system comprising:
a rotor disk; and
a brake member comprising the friction material of claim 1.

18. A friction material for a brake system, the friction material comprising:
about 1.0% to about 10.0% by weight of a solid lubricant including a metal sulfide;
about 6.0% to 15.0% by weight of a binder;
about 2.0% to 15.0% by weight of an abrasive; and
one or more fillers; and
wherein the friction material is substantially free of elemental metal and metal alloy.

19. The friction material of claim 18, wherein the friction material is substantially free of elemental metal and metal alloy selected from the group consisting of elemental iron, steel, elemental tin, elemental zinc, elemental copper, elemental aluminum, elemental lead, elemental titanium, tin alloy, zinc alloy, copper alloy, aluminum alloy, and magnesium alloy.

20. The friction material of claim 18, further comprising less than about 20.0% by weight of non-metal fiber.
